(19) United States
(12) Patent Application Publication
(10) Pub. No.: US 2022/0125665 A1
(43) Pub. Date: Apr. 28, 2022

(54) MASSAGE DEVICES, MASSAGE ELEMENTS, AND METHODS FOR RELIEVING SOFT TISSUE PAIN AND TENSION

(71) Applicant: Jason Allen, Columbus, OH (US)

(72) Inventor: Jason Allen, Columbus, OH (US)

(21) Appl. No.: 17/509,601

(22) Filed: Oct. 25, 2021

Related U.S. Application Data
(60) Provisional application No. 63/104,816, filed on Oct. 23, 2020.

(51) Int. Cl. A61H 7/00

(52) U.S. Cl. CPC A61H 7/002; A61H 2201/0126; A61H 2205/081; A61H 2205/086; A61H 2201/1253; A61H 2205/108; A61H 2205/106; A61H 2205/04; A61H 2205/062

(57) ABSTRACT

A massage device that includes a wall-mountable support structure and one or more massage elements. The one or massage elements may include a first massage element, a second massage element, and a third massage element. The first massage element has massage heads positioned to provide massage to a user's cervical paraspinal muscles, trapezius muscles, deltoid muscles, and rhomboid muscles. The second massage element has massage heads positioned to provide massage to the user's latissimus dorsi muscles and thoracic paraspinal muscles. The third massage element has massage heads positioned to provide massage to the user's thoracic paraspinal muscles, oblique muscles, and gluteus maximus muscles.

### CROSS-REFERENCE TO RELATED APPLICATION(S)

This application claims priority to and any benefit of U.S. Provisional Application No. 63/104,816, filed Oct. 23, 2020, the content of which is incorporated herein by reference in its entirety.

### TECHNICAL FIELD

The present invention generally relates to massage devices, massage elements, and methods for performing massage therapy using such massage devices and massage elements. The massage devices, massage elements, and methods of the present invention may be used to provide massage therapy to users in order to, for example, relieve soft tissue pain and tension, manage or treat medical conditions, or promote overall health and wellness.

### BACKGROUND

Massage therapy has long been used to treat disorders of the human body and enhance overall wellness. In general, massage therapy involves manipulating an individual's soft tissues, including but not limited to muscles, tendons, ligaments, and connective tissues, by pressing, kneading, rubbing, or otherwise manipulating the tissues to provide a therapeutic or other beneficial effect. Massage therapy is used for a variety of reasons, such as relieving stress, promoting wellness, treating specific injuries or disorders, managing heath conditions, and promoting healing. Most commonly, massage therapy is used to relieve pain and tension in muscles or other soft tissues of the body.

Soft tissue pain and tension can have many causes. For example, various medical conditions are characterized by soft tissue ailments and pain. Fibromyalgia, for instance, is a condition associated with widespread chronic musculoskeletal pain that may also cause fatigue, sleep disturbances, and tenderness to touch. Similarly, many people suffer from myofascial pain syndrome, which is a chronic pain disorder in which pressure in sensitive points in a person's muscles cause radiating pain in other parts of the person's body. These conditions, as well as many others characterized by soft tissue ailments and pain, are often treated using massage therapy.

Myofascial trigger points are another common cause of soft tissue pain and, in particular, muscle pain. Trigger points are hyperirritable spots found in taut bands of muscle and are associated with palpable nodules, or “knots,” in the muscle. Trigger points are caused when a small number of muscle fibers in a larger group of muscle fibers contract, which can result in local pain or radiating pain that affects other parts of the body. Although trigger points may occur in muscles throughout the body, trigger points often develop in the muscles of the neck, shoulders, back, and legs. Massage therapy is commonly used to treat trigger points, such as by massaging and applying pressure to affected muscles to release contractions and relax muscles, or “release” the trigger points.

Without wishing to be bound by theory, massage may relieve soft tissue pain in several ways. For example, massaging muscles of the body may cause muscle tissue to relax, which may reduce painful muscle contractions and spasms. Muscles that are in a contracted state may also cause pain by compressing surrounding nerves, which may be eliminated by relaxing the muscles through massage. In addition to relaxing muscle tissue, massage may also improve blood flow and circulation, which enhances the delivery of oxygen and other nutrients to muscles and other areas of the body. It has also been theorized that massage sets off a series of molecular events in the body, including triggering the release of natural painkillers and hormones that further relax muscles in the body, as well as dampening the activity of certain molecules such as inflammatory cytokines that cause inflammation and pain.

### SUMMARY

The present invention provides devices and methods for providing massage and/or massage therapy to users. In one exemplary embodiment, a massage device for providing massage to a user's body includes a wall-mountable support structure and one or more massage elements attached to the wall-mountable support structure.

The wall mountable support structure can take several forms. In one embodiment, the wall-mountable support structure includes a wall-mountable frame. The wall-mountable frame may include one or more upright assemblies, one or more cross bar assemblies, one or more lateral assemblies, and/or one or more medial assemblies In another embodiment, the wall-mountable support structure comprises one or more wall-mountable pegboard assemblies. The wall-mountable pegboard assemblies may include a pegboard with a plurality of openings.

The massage elements can likewise take a wide variety of different forms. In one embodiment, a massage element for providing massage to a user's cervical paraspinal muscles, trapezius muscles, deltoid muscles, and rhomboid muscles includes a body with a pair of side members and a connecting member extending between the side members, a first pair of arms that extend vertically from the side members of the body and include one or more massage heads positioned to contact the user's cervical paraspinal muscles, a second pair of arms that extend outwardly from the side members of the body, one or more prongs that extend upwardly from the second pair of arms and include one or more massage heads positioned to contact the user's trapezius and deltoid muscles, and a pair of legs that extend downwardly from the second pair of arms and include one or more massage heads positioned to contact the user's rhomboid muscles. In another embodiment, a massage element for providing massage to a user's latissimus dorsi muscles and thoracic paraspinal muscles includes a body with a pair of side members and a connecting member extending between the side members. The side members include one or more massage heads positioned to contact the user's latissimus dorsi muscles and thoracic paraspinal muscles. In another embodiment, a massage element for providing massage to a user's thoracic paraspinal muscles, oblique muscles, and gluteus maximus muscles includes a body with a pair of side members and a connected member extending between the side members, a pair of arms that extend vertically from the side members of the body and include one or more massage heads positioned to contact the user's thoracic paraspinal muscles and oblique muscles, and a pair of legs that extend downwardly and outwardly from the side members of the body and include one or more massage heads positioned to contact the user's gluteus maximus muscles. In another embodiment, a massage element for providing massage to a user's deltoid muscles includes a planar body and one or more prongs that extend outwardly from the planar body and include one or more massage heads positioned to contact the user's deltoid muscles. In another embodiment, a massage element for providing massage to a user's iliotibial bands includes a planar body and one or more prongs that extend outwardly from the planar body and include one or more massage heads positioned to contact the user's iliotibial bands. In another embodiment, a massage element for providing massage to a lateral head of a user's gastrocnemius muscles includes a planar body and one or more prongs that extend outwardly from the planar body and include one or more massage heads positioned to contact the lateral head of the user's gastrocnemius muscles. In another embodiment, a massage element for providing massage to a medial head of a user's gastrocnemius muscles includes a planar body and one or more prongs that extend outwardly from the planar body and include one or more massage heads positioned to contact the medial head of the user's gastrocnemius muscles.

### BRIEF DESCRIPTION OF THE DRAWINGS

The invention will now be explained and other advantages and features will appear with reference to the accompanying drawings wherein:

FIG. 1 is a posterior view of a human body showing various muscles of the neck, shoulders, back, and legs;

FIG. 2 is a schematic front view of an embodiment of a massage device of the present invention;

FIG. 3 is a schematic front view of an embodiment of a massage device of the present invention;

FIG. 4 is a side view of the massage device of FIG. 3;

FIG. 5 is a schematic front view of an embodiment of a massage device of the present invention;

FIG. 6 is a schematic front view of an embodiment of a massage device of the present invention;

FIG. 7A is a front view of an embodiment of a massage element of the present invention;

FIG. 7B is a side view of the massage element of FIG. 7A;

FIG. 7C is a perspective view of the massage element of FIG. 7A;

FIG. 8A is a front view of an embodiment of a massage element of the present invention;

FIG. 8B is a side view of the massage element of FIG. 8A;

FIG. 8C is a perspective view of the massage element of FIG. 8A;

FIG. 9A is a front view of an embodiment of a massage element of the present invention;

FIG. 9B is a side view of the massage element of FIG. 9A;

FIG. 9C is a perspective view of the massage element of FIG. 9A;

FIG. 10A is a front view of an embodiment of a massage element of the present invention;

FIG. 10B is a side view of the massage element of FIG. 10A;

FIG. 10C is a perspective view of the massage element of FIG. 10A;

FIG. 11A is a front view of an embodiment of a massage element of the present invention;

FIG. 11B is a side view of the massage element of FIG. 11A;

FIG. 11C is a perspective view of the massage element of FIG. 11A;

FIG. 12A is a front view of an embodiment of a massage element of the present invention;

FIG. 12B is a side view of the massage element of FIG. 12A;

FIG. 12C is a perspective view of the massage element of FIG. 12A;

FIG. 13 is a front view of an embodiment of a massage device of the present invention;

FIG. 14 is a side view of the massage device of FIG. 13;

FIG. 15 is a front view of an embodiment of a massage device of the present invention;

FIG. 16 is a side view of the massage device of FIG. 15;

FIG. 17 is a front view of an embodiment of a massage device of the present invention shown in use by a user; and

FIG. 18 is a side view of the massage device of FIG. 17 shown in use by a user.

### DETAILED DESCRIPTION

The general inventive concepts will now be described with occasional reference to the exemplary embodiments of the invention. These general inventive concepts may, however, be embodied in different forms and should not be construed as limited to the embodiments set forth herein. Rather, these embodiments are provided so that this disclosure will be thorough and complete and will fully convey the scope of the general inventive concepts to those skilled in the art.

Embodiments of the present invention include massage devices and massage elements for providing massage and/or massage therapy to users. Massage devices of the present invention are preferably mountable to a wall or other support structure, allowing users to self-administer massage. Massage devices of the present invention generally include one or more massage elements, each with one or more massage heads that contact and provide massage to users. In some embodiments, massage devices of the present invention may include a plurality of massage elements that are each specifically designed to provide massage to a particular area of users' bodies, such as a particular region, muscle, or muscle group. Embodiments of the present invention also include massage elements that may be used together or separately from the massage devices of the present invention. Massage elements of the present invention may take a variety of forms in order to provide massage to different areas of users' bodies. In some embodiments, massage devices and/or massage elements of the present invention are used to provide therapeutic or other beneficial effects to a user, including but not limited to relief of users' soft tissue pain or tension.

The massage devices and massage elements of the present invention will be discussed with regard to their use in relieving soft tissue pain or tension, such as for example muscle pain caused by trigger points in users' muscles. Those skilled in the art will appreciate, however, that the inventions disclosed herein have broader applications in the therapeutic art. Although the present disclosure discusses use of the massage devices and massage elements of the present invention for relief of soft tissue pain or tension, it is contemplated that the present inventions or features thereof may be used for other purposes as well, including but not limited to use by a user to: (1) treat or manage injuries, ailments, disorders, or health conditions; (2) promote healing; (3) increase blood circulation; (4) reduce or relieve stress or anxiety; (5) promote relaxation; (6) improve flexibility; (7) promote muscle recovery; (8) reduce markers of muscle damage, soreness, fatigue, and inflammation; (9) reduce or recover from delayed onset muscle soreness; and (10) promote or enhance overall mood, happiness, health, or wellness.

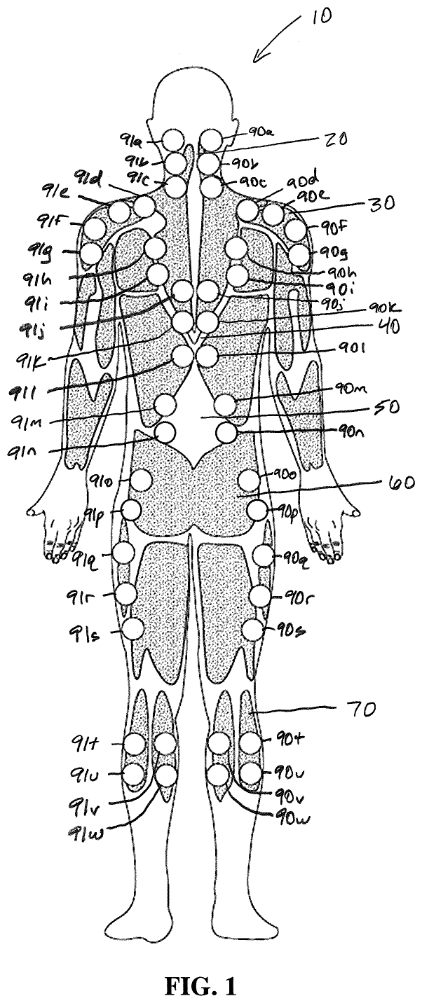

As described above, individuals may experience pain, tension, or discomfort in numerous areas throughout the body. FIG. 1 shows a posterior view of an exemplary human body 10 and identifies the general location of various exemplary areas or regions of the human body 10 in which an individual may experience pain. The areas or regions referred to herein may encompass many different soft tissues, including muscles, muscle groups, tendons, ligaments, and/or connective tissues, all of which may be a source of or an area in which an individual may experience pain.

Human body 10 includes cervical region 20, deltoid region 30, thoracic region 40, lumbar region 50, gluteal region 60, and lower limb region 70. Cervical region 20 may include various soft tissues including but not limited to the cervical paraspinal muscles and the upper portion of the trapezius muscles. Deltoid region 30 may include various soft tissues including but not limited to the deltoid muscles. Thoracic region 40 may include various soft tissues including but not limited to the middle and lower portions of the trapezius muscles, the rhomboid muscles, the latissimus dorsi muscles, and the thoracic paraspinal muscles. The lumbar region 50 may include various soft tissues including but not limited to the lumbar paraspinal muscles and the oblique muscles. The gluteal region 60 may include various soft tissues including but not limited to the gluteus maximus muscles. The iliotibial band (IT band), which is a tendon that runs down the length of the outer thigh, is also located generally in the gluteal region. The lower limb region 70 may include various soft tissues including but not limited to the gastrocnemius muscles (also referred to as the calf muscles). The gastrocnemius muscles further comprise a lateral head and a medial head.

An individual may experience pain, tension, or discomfort in the regions and/or soft tissues discussed above in relation to FIG. 1. Embodiments of the present invention include massage devices and/or massage elements that provide massage to one or more area of a user's body, including but not limited to the regions and/or soft tissues referenced above, in order to relive pain, tension, or discomfort. In some embodiments, massage devices of the present invention include massage elements with massage heads that contact and provide massage to regions and/or soft tissues of a user's body including but not limited to those referred to above.

In some embodiments, massage devices of the present invention include massage elements with massage heads that contact and massage a user's body at particular locations in order to relieve pain or tension. Referring still to FIG. 1, points 90a-90w and 91a-91w are shown on exemplary human body 10. In some embodiments, massage heads of massage elements of the present invention contact and massage a user's body at locations approximately corresponding to one or more of points 90a-90w and 91a-91w shown on exemplary human body 10. In some embodiments, points 90a-90w and 91a-91w may be generally located within the regions of human body 10 referred to above. For example, points 90a-90c and 91a-91c may be located within cervical region 20. In some embodiments, points 90a-90w and 91a-91w may be superficial to soft tissues, including but not limited to the muscles and other soft tissues discussed above. For example, points 90a-90c and 91a-91c may be superficial to the cervical paraspinal muscles and/or the upper portion of the trapezius muscles.

Persons of ordinary skill in the art would understand that points 90a-90w and 91a-91w are approximate. Users of the massage devices and/or massage elements of the present invention may have different body shapes, sizes, or dimensions and as such the location of points 90a-90w and 91a-91w may differ slightly from one user to another. Additionally, massage devices and/or massage elements of the present invention need not in all embodiments include massage heads that contact and massage a user's body at locations approximately corresponding to each of points 90a-90w and 91a-91w. In some embodiments, massage devices and/or massage elements of the present invention include massage heads that contact a user's body at locations corresponding to each of points 90a-90w and 91a-91w. In other embodiments, massage devices and/or massage elements of the present invention include massage heads that contact a user's body at locations corresponding to a subset of points 90a-90w and/or 91a-91w. Various embodiments of massage devices and/or massage elements having massage heads that are intended to contact a user's body at locations corresponding to one or more of points 90a-90w and 91a-91w are described further below.

Persons of ordinary skill in the art will understand that massage devices, massage elements, and/or massage heads of the present invention are intended to contact a user on an external surface of the user's body (i.e., the skin). It will be appreciated, however, that contacting and massaging an external surface of a user's body will simultaneously massage areas of the user's body underlying the external surface (e.g., soft tissues). Thus, references to massage devices, massage elements, and/or massage heads of the present invention contacting and massaging particular areas, including but not limited to the regions and/or soft tissues referred to above and/or points 90a-90w and/or 91a-91w, should be understood to encompass contacting external surfaces of a user's body and massaging both external surfaces and underlying areas of a user's body including but not limited to underlying soft tissues.

Persons of ordinary skill in the art will further understand that the regions, muscles, muscle groups, and other soft tissues identified herein are exemplary. The human body includes many regions, muscles, muscle groups, and other soft tissues in addition to those specifically referred to herein, including but not limited to regions, muscles, muscle groups, and soft tissues that are adjacent, anterior, posterior, superior, inferior, lateral, medial, superficial, or deep to the areas discussed above. It will be appreciated by persons of ordinary skill in the art that embodiments of the present invention may contact and massage regions, muscles, muscle groups, and soft tissues in addition to those specifically referred to herein, in order to for example relive pain, tension, or discomfort in those areas. Although reference may be made to the regions and/or soft tissues discussed above in relation to FIG. 1, it should be understood that the present invention is not intended to be limited to massage devices, massage elements, and/or massage heads that massage only these areas.

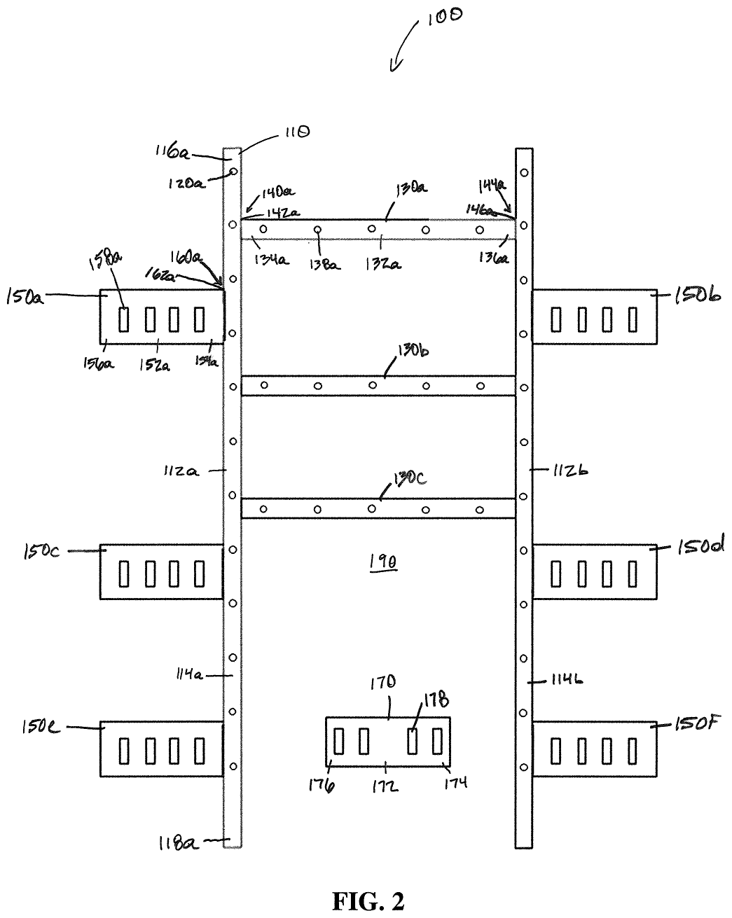

Referring now to FIGS. 2-6, various embodiments of massage devices of the present invention are illustrated and described below. In general, massage devices of the present invention may include a wall-mountable support structure and optionally one or more massage elements coupled to the wall-mountable support structure. In some embodiments, the wall-mountable support structure may be a wall-mountable frame. The wall-mountable frame may include one or more upright assemblies. In some embodiments, the wall-mountable frame may further include one or more cross bar assemblies, one or more lateral assemblies, and/or one or more medial assemblies. In alternate embodiments, the wall-mountable support structure may be one or more wall-mountable pegboard assemblies.

FIG. 2 shows a schematic illustration of one embodiment of a massage device of the present invention. In this embodiment, massage device 100 includes a wall-mountable support structure which may be frame 110. Frame 110 includes upright assemblies 112, cross bar assemblies 130, optional lateral assemblies 150, and optional medial assembly 170. In other embodiments, one or more massage elements (not shown) may be attached to frame 110.

More specifically, in the embodiment illustrated in FIG. 2, frame 110 includes a first upright assembly 112a and a second upright assembly 112b. The first upright assembly 112a and second upright assembly 112b generally extend vertically upward from the ground or floor and are attachable to a wall or other solid support structure 190. First upright assembly 112a and second upright assembly 112b may be substantially mirror images of one another. The description below will refer to first upright assembly 112a but persons of ordinary skill in the art would appreciate that this description would apply equally to second upright assembly 112b.

First upright assembly 112a includes a main bar 114a. Main bar 114a is typically constructed as a square or rectangular tube having flat mounting surfaces, although other shaped tubular constructions with suitable mounting faces are also contemplated. Main bar 114a may be a hollow tube or may be a substantially solid body and may be formed of any rigid material such as metal alloys or wood.

Main bar 114a includes an upper end 116a, lower end 118a, and a plurality of openings 120a. The upper end 116a and lower end 118a are opposite one another with the main bar 114a extending between. Openings 120a extend through the front and back of the main bar 114a, as well as through opposing sides of main bar 114a. Openings 120a are distributed along the length of the main bar 114a. The number, size, and shape of openings 120a, as well as the spacing between openings 120a, may vary. In some embodiments, openings 120a are circular. In other embodiments, openings 120a are defined as a first circle with an elongated circle extending downwardly. In some embodiments, openings 120a are used to couple one or more cross bar assemblies 130 and/or one or more lateral assemblies 150 to first upright assembly 112a.

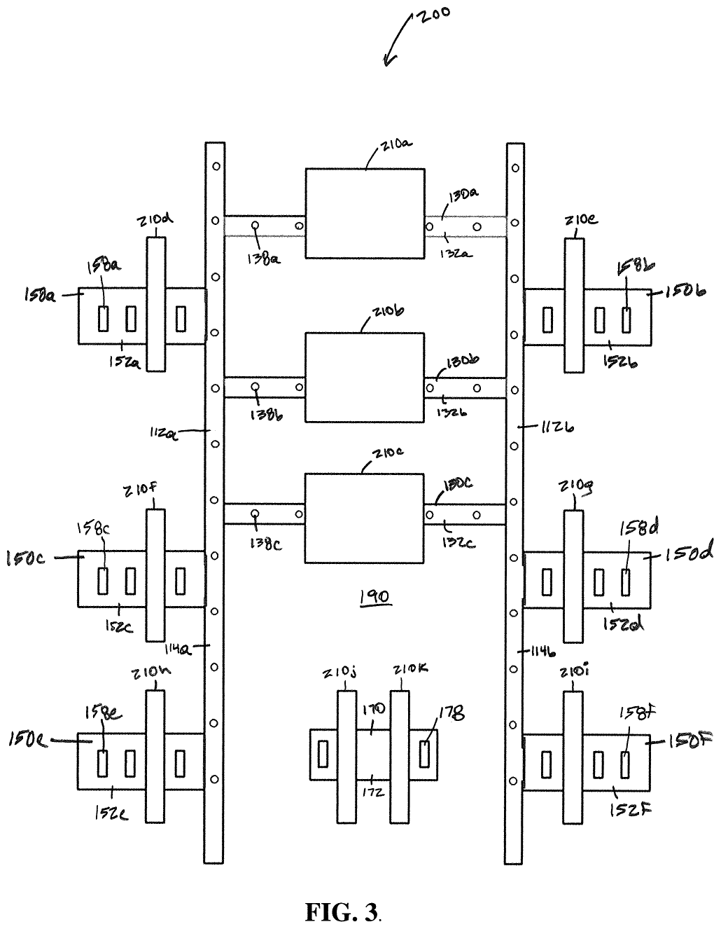

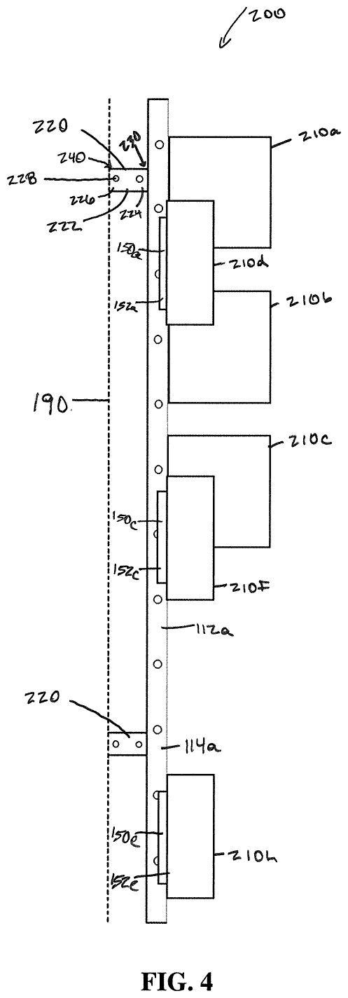

First upright assembly 112a may be connected directly to a wall or other solid support structure 190 using means known in the art including brackets, bolts, screws, and the like. In alternate embodiments (shown in FIGS. 3 and 4), first upright assembly 112a may further include one or more spacer assemblies that extend between main bar 114a and a wall or solid support structure 190 to facilitate attachment.

Frame 110 may further include cross bar assemblies 130. Cross bar assemblies 130 join first upright assembly 112a and second upright assembly 112b. In some embodiments, massage elements (not shown in FIG. 2) may be mounted to cross bar assemblies 130. In some embodiments, cross bar assemblies 130 are movable in an upward or downward direction along upright assemblies 112 to accommodate users of varying size or height.

In the embodiment illustrated in FIG. 2, frame 110 includes a first cross bar assembly 130a, a second cross bar assembly 130b, and a third cross bar assembly 130c. First cross bar assembly 130a, second cross bar assembly 130b, and third cross bar assembly 130c may be substantially identical. The description below will refer to first cross bar assembly 130a but persons of ordinary skill in the art would appreciate that this description would apply equally to the second cross bar assembly 130b and third cross bar assembly 130c.

First cross bar assembly 130a includes main cross bar 132a, first upright coupling 140a, and second upright coupling 144a. Main cross bar 132a is typically constructed as a square or rectangular tube having flat mounting surfaces, although other shaped tubular constructions with suitable mounting faces are also contemplated. Main cross bar 132a may be a hollow tube or may be a substantially solid body and may be formed of any rigid material such as metal alloys or wood.

Main cross bar 132a includes first end 134a, second end 136a, and a plurality of openings 138a. The first end 134a and second end 136a are opposite one another with the main cross bar 132a extending between. The first end 134a is proximal to the main bar 114a of first upright assembly 112a. The second end 136a is proximal to the main bar 114b of second upright assembly 112b.

First upright coupling 140a facilitates coupling of first cross bar assembly 130a to main bar 114a of the first upright assembly 112a. First upright coupling 140a may include any means known in the art for attaching first cross bar assembly 130a to main bar 114a of first upright assembly 112a, such as by bolts, screws, and the like. In some embodiments, first cross bar assembly 130a is permanently attached to main bar 114a of first upright assembly 112a.

In one embodiment, first upright coupling 140a includes a first flange 142a located at the first end 134a of main cross bar 132a. First flange 144a is proximal to main bar 114a of first upright assembly 112a. First flange 144a includes one or more holes (not shown). In some embodiments, pins (not shown) may be inserted through holes in first flange 144a and into openings 120a on main bar 114a of first upright assembly 112a to removably couple main bar 114a of first upright assembly 112a to first cross bar assembly 130a. In other embodiments, alternate attachment means known in the art such as bolts or screws may be used in place of pins.

Second upright coupling 144a facilitates coupling of first cross bar assembly 130a to main bar 114b of the second upright assembly 112b. Second upright coupling 144a may include any means known in the art for attaching first cross bar assembly 130a to main bar 114b of the second upright assembly 112b, such as by bolts, screws, and the like. In some embodiments, first cross bar assembly 130a is permanently attached to main bar 114b of second upright assembly 112b.

In one embodiment, second upright coupling 144a includes a second flange 146a located at the second end 136a of main cross bar 132a. Second flange 146a is proximal to main bar 114b of second upright assembly 112b. Second flange 146a includes one or more holes (not shown). In some embodiments, pins (not shown) may be inserted through the holes in second flange 146a and into openings 120b on main bar 114b of second upright assembly 112b to removably couple main bar 114b of second upright assembly 112b to first cross bar assembly 130a. In other embodiments, alternate attachment means known in the art such as bolts or screws may be used in place of pins.

In preferred embodiments, first upright coupling 140a and second upright coupling 144a allow first cross bar assembly 130a to be coupled to and decoupled from the first upright assembly 112a and second upright assembly 112b, respectively. As such, first cross bar assembly 130a may be movable in an upward or downward direction along the length of upright assemblies 112 to accommodate users of varying size or height.

As described above, main cross bar 132a of first cross bar assembly 130a includes a plurality of openings 138a. Openings 138a extend through the front and back of the main cross bar 132a, as well as through the top and bottom of main cross bar 132a. Openings 138a are distributed along the length of the main cross bar 132a. The number, size, and shape of openings 138a, as well as the spacing between openings 138a, may vary. In some embodiments, openings 138a are circular. In other embodiments, openings 138a are defined as a first circle with an elongated circle extending downwardly. Openings 138a may be used to mount one or more massage elements (not shown) to first cross bar assembly 130a.

As described above, massage devices of the present invention may optionally include one or more lateral assemblies. Referring still to FIG. 2, frame 110 includes optional lateral assemblies 150, which may be coupled to upright assemblies 112. In some embodiments, massage elements (not shown) may be mounted to lateral assemblies 150. In some embodiments, lateral assemblies 150 are movable in the upward or downward direction along the length of upright assemblies 112 to accommodate users of varying size or height.

In the embodiment shown in FIG. 2, frame 110 includes a first lateral assembly 150a, a second lateral assembly 150b, a third lateral assembly 150c, a fourth lateral assembly 150d, a fifth lateral assembly 150e, and a sixth lateral assembly 150f. First lateral assembly 150a, third lateral assembly 150c, and fifth lateral assembly 150e may be substantially identical. Second lateral assembly 150b, fourth lateral assembly 150d, and sixth lateral assembly 150f may be substantially identical and substantially mirror images of first lateral assembly 150a. Thus, the description below will refer to the first lateral assembly 150a but persons of ordinary skill in the art would appreciate that this description would apply equally to the other lateral assemblies 150.

First lateral assembly 150a includes panel portion 152a and upright coupling 160a to facilitate coupling of first lateral assembly 150a to the main bar 114a of the first upright assembly 112a.

The panel portion 152a includes first end 154a, second end 156a, and a plurality of openings 158a. The first end 154a and second end 156a are opposite one another with panel portion 152a extending between. The first end 154a is proximal to the main bar 114a of first upright assembly 112a.

First upright coupling 160a facilitates coupling of the first lateral assembly 150a to the main bar 114a of the first upright assembly 112a. The first upright coupling 160a may include any means known in the art for attaching first lateral assembly 150a to the main bar 114a of the first upright assembly 112a, such as by bolts, screws, and the like. In some embodiments, first lateral assembly 150a is permanently attached to main bar 114a of first upright assembly 112a.

In one embodiment, first upright coupling 160a includes a first flange 162a located at the first end 154a of panel portion 152a. First flange 162a is proximal to main bar 114a of first upright assembly 112a. First flange 162a includes one or more holes (not shown). In some embodiments, pins (not shown) may be inserted through the holes in first flange 162a and into openings 120a on main bar 114a of first upright assembly 112a to removably couple main bar 114a of first upright assembly 112a to first lateral assembly 150a. In other embodiments, alternate attachment means known in the art such as bolts or screws may be used in place of pins.

In preferred embodiments, first upright coupling 160a allows first lateral assembly 150a to be coupled to and decoupled from the first upright assembly 112a. As such, first lateral assembly 150a may be movable in a vertical direction along the length of the first upright assembly 112a to accommodate users of varying size or height.

As described above, panel portion 152a of first lateral assembly 150a includes a plurality of openings 158a. Openings 158a extend through the front and back of the panel portion 152a. Openings 158a are distributed across the surface of panel portion 152a. The number, size, and shape of openings 158a, as well as the spacing between openings 158a, may vary. In some embodiments, openings 158a are circular. In other embodiments, openings 158a are defined as a first circle with an elongated circle extending downwardly. In some embodiments, openings 158a are used to mount one or more massage elements (not shown) to first lateral assembly 150a.

As described above, massage devices of the present invention may optionally include one or more medial assemblies. Referring still to FIG. 2, frame 110 includes optional medial assembly 170, which may be mounted to a wall or other support structure 190 in the manner described herein for mounting first upright assembly 112a to a wall or other solid support structure 190 or using any other means known in the art. In some embodiments, massage elements (not shown in FIG. 2) may be mounted to medial assembly 170.

In the embodiment shown in FIG. 2, medial assembly 170 includes panel portion 172. Panel portion 172 includes first end 174, second end 176, and a plurality of openings 178. The first end 174 and second end 176 are opposite one another with panel portion 172 extending between.

Openings 178 extend through the front and back of the panel portion 172. Openings 178 are distributed across the surface of plate portion 178. The number, size, and shape of openings 178, as well as the spacing between openings 178, may vary. In some embodiments, openings 178 are circular. In other embodiments, openings 178 are defined as a first circle with an elongated circle extending downwardly. In some embodiments, openings 178 are used to mount one or more massage elements (not shown) to medial assembly 170.

FIGS. 3 and 4 show schematic illustrations of another embodiment of a massage device of the present invention. Massage device 200 is similar to massage device 100 shown in FIG. 2 in all respects other than those specifically described herein. Like reference numerals in FIGS. 3 and 4 refer to like features in FIG. 2.

As indicated above, massage devices of the present invention may optionally further include one or more massage elements. Massage elements of the present invention may take a variety of forms and any massage element can be used with the massage devices described herein. Various embodiments of massage elements that may be used with the massage devices of the present invention are described below.

Massage device 200 may include massage elements 210. More specifically, in this embodiment, massage device 200 includes massage elements 210a, 210b, 210c, 210d, 210e, 210f, 210g, 210h, 210i, 210j, and 210k. Persons of ordinary skill in the art would appreciate that massage device 200 may include all or a subset of massage elements 210 shown in FIGS. 3 and 4. Further, it will be understood that massage elements 210 may be mounted at different locations on massage device 200 depending on the application.

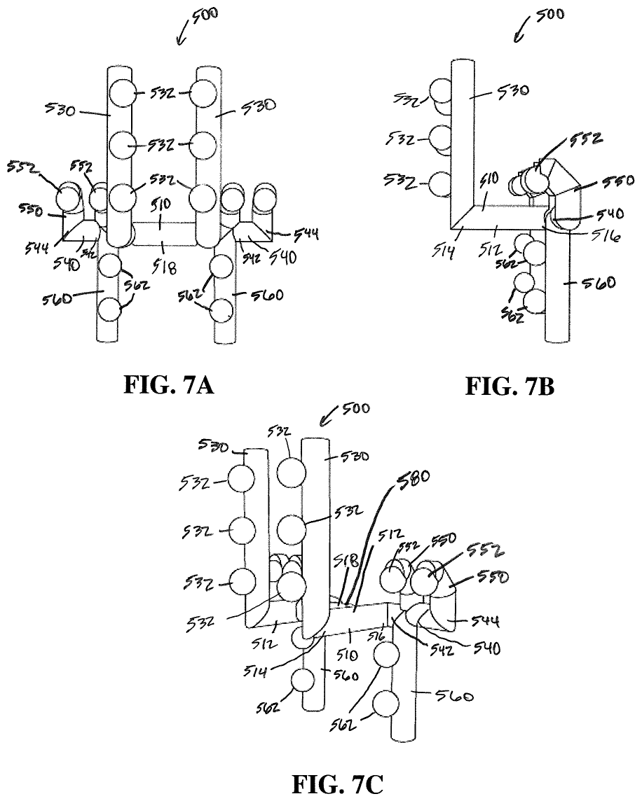

In some embodiments, massage element 210a may be mounted to first cross bar assembly 130a of massage device 200. Preferably, massage element 210a provides massage to one or more of a user's cervical, deltoid, or thoracic regions and/or soft tissues generally located within one or more of these regions including but not limited to a user's cervical paraspinal muscles, trapezius muscles, deltoid muscles, or rhomboid muscles. Massage element 210a may take many forms, including but not limited to the exemplary embodiment shown in FIGS. 7A-7C and described below.

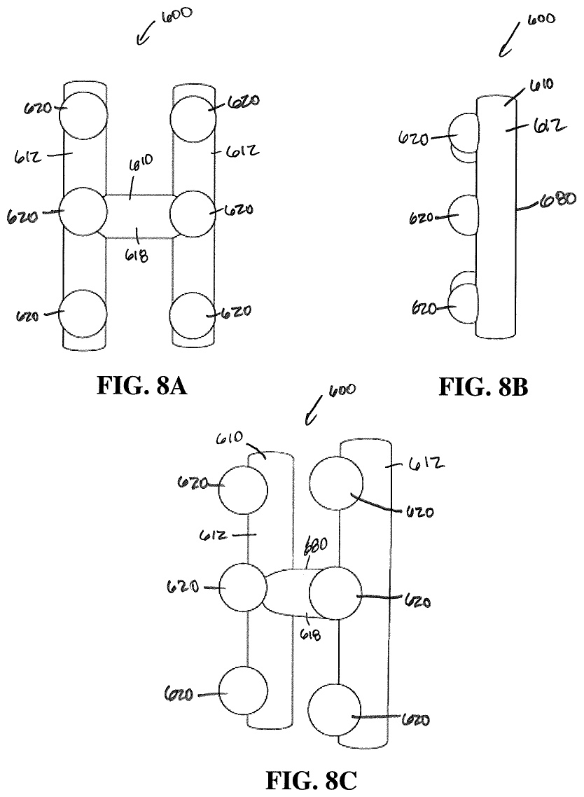

In some embodiments, massage element 210b may be mounted to second cross bar assembly 130b of massage device 200. Preferably, massage element 210b provides massage to a user's thoracic region and/or soft tissues generally located within this region including but not limited to a user's latissimus dorsi muscles or thoracic paraspinal muscles. Massage element 210b may take many forms, including but not limited to the exemplary embodiment shown in FIGS. 8A-8C and described below.

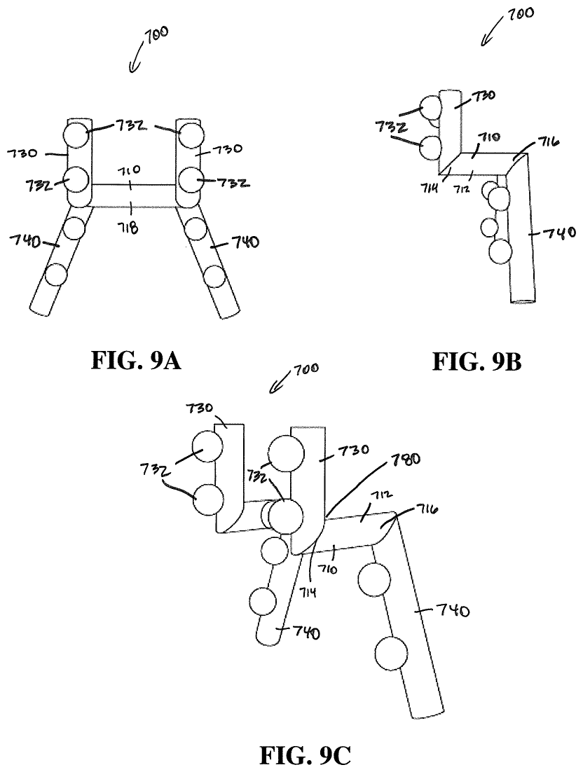

In some embodiments, massage element 210c may be mounted to third cross bar assembly 130c of massage device 200. Preferably, massage element 210c provides massage to one or more of a user's lumbar or gluteal regions and/or soft tissues generally located within one or more of these regions including but not limited to a user's thoracic paraspinal muscles, oblique muscles, or gluteus maximus muscles. Massage element 210c may take many forms, including but not limited to the exemplary embodiment shown in FIGS. 9A-9C and described below.

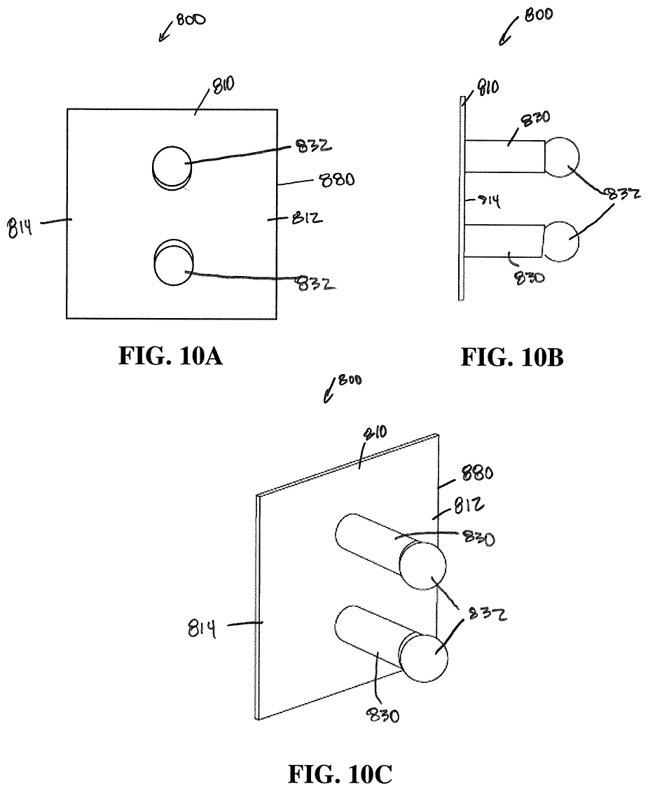

In some embodiments, massage elements 210d and 210e may be mounted to first lateral assembly 150a and second lateral assembly 150b, respectively, of massage device 200. Preferably, massage elements 210d and 210e provide massage to a user's deltoid regions and/or soft tissues generally located within these regions including but not limited to a user's deltoid muscles. Massage elements 210d and 210e may take many forms, including but not limited to the exemplary embodiment shown in FIGS. 10A-10C and described below.

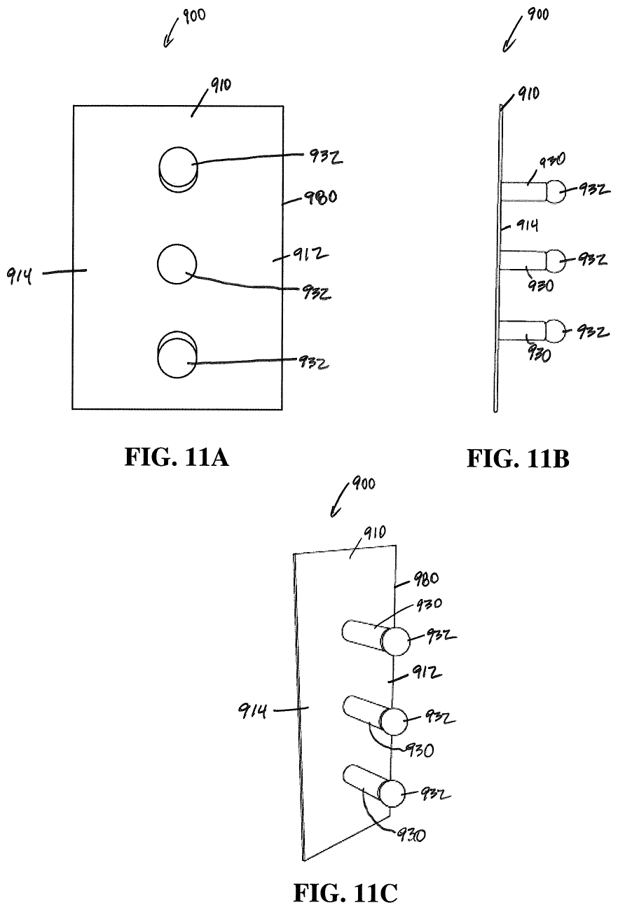

In some embodiments, massage elements 210f and 210g may be mounted to third lateral assembly 150c and fourth lateral assembly 150d, respectively, of massage device 200. Preferably, massage elements 210f and 210g provide massage to a user's gluteal region and/or soft tissues generally located within this region including but not limited to a user's iliotibial bands. Massage elements 210f and 210g may take many forms, including but not limited to the exemplary embodiment shown in FIGS. 11A-11C and described below.

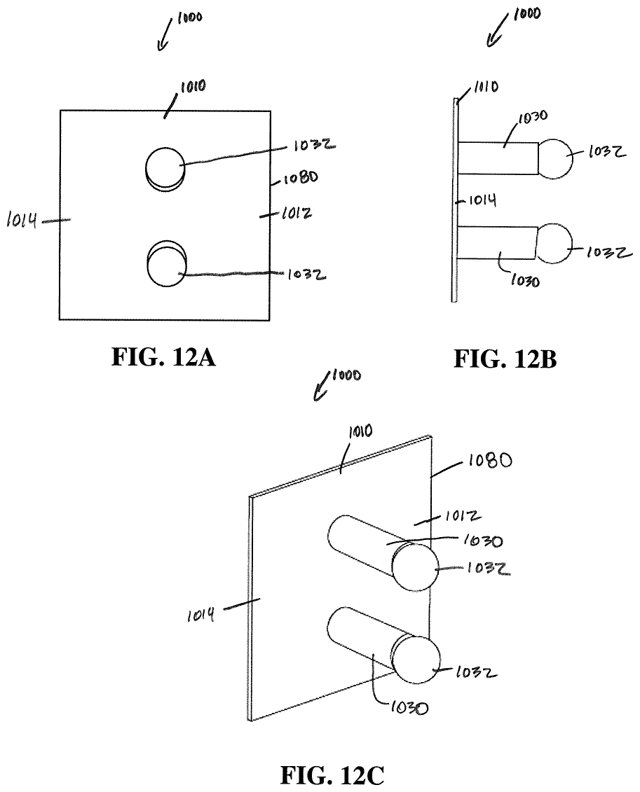

In some embodiments, massage elements 210h and 210i may be mounted to fifth lateral assembly 150e and sixth lateral assembly 150f, respectively, of massage device 200. Preferably, massage elements 210h and 210i provide massage to a user's lower limb regions and/or soft tissues generally located within these regions including but not limited to the lateral heads of a user's gastrocnemius muscles. Massage elements 210h an d210i may take many forms, including but not limited to the exemplary embodiment shown in FIGS. 12A-12C and described below.

In some embodiments, massage elements 210j and 210k may be mounted to medial assembly 170 of massage device 200. Preferably, massage elements 210j and 210k provide massage to a user's lower limb regions and/or soft tissues generally located within these regions including but not limited to the medial heads of a user's gastrocnemius muscles. Massage element 210j and 210k may take many forms, including but not limited to the exemplary embodiment shown in FIGS. 12A-12C and described below.

Massage elements 210 may be mounted to massage device 200 in a variety of ways. In some embodiments, massage elements 210 may include a mounting mechanism (not shown in FIGS. 3 and 4). For example, mounting mechanism may include one or more pins situated on massage elements 210 that may be inserted into one or more openings 138 in main cross bars 132 of cross bar assemblies 130, one or more openings 158 in panel portion 152 of lateral assemblies 150, and/or one or more openings 178 in panel portion 172 of medial assembly 170 to removably couple one or more massage elements 210 to massage device 200. In embodiments in which openings 138, 158, and/or 178 are defined as a first circle with an elongated circle extending downwardly as described above, one or more pins of mounting mechanism of massage elements 210 may be defined as a first rod member terminating in a bulbous end, which may be inserted into one or more openings 138, 158, and/or 178 before sliding down into a locked position such that the one or more massage elements 210 are securely and removably coupled to massage device 200. In other embodiments, alternate mounting mechanisms may be used to facilitate coupling massage elements 210 to massage device 200, including but not limited to screws, bolts, or any other suitable means to facilitate coupling. In other embodiments, massage elements 210 may be permanently attached to massage device 200. In some embodiments, massage elements 210 may be affixed at various locations across main cross bars 132 of cross bar assemblies 130, panel portion 152 of lateral assemblies 150, and/or panel portion 172 of medial assembly 170 to accommodate users of varying size or height.

Referring to FIG. 4, one or more spacer assemblies may be used to connect massage devices of the present invention to a wall or other support structure, as referred to above. In this embodiment, upright assemblies 112 may further include spacer assemblies 220, which connect upright assemblies 112 to wall 190. Spacer assemblies 220 include main spacer bar 222, upright coupling 230, and wall coupling 240. Main spacer bar 222 may vary in length and is typically constructed in the manner described herein for main bar 114 of upright assembly 112. Main spacer bar 222 includes first end 224, second end 226, and a plurality of openings 228. The first end 224 and second end 226 are opposite one another with the main spacer bar 222 extending between. The first end 224 is proximal to main bar 114 of upright assembly 112. The second end 226 is proximal to wall 190. Upright coupling 230 facilitates coupling of spacer assembly 220 to main bar 114 of upright assembly 112. Wall coupling 240 facilitates coupling of spacer assembly 220 to wall 190. Upright coupling 230 and wall coupling 240 may include any means for coupling described herein for upright couplings 140 and 144 of cross bar assemblies 130 or any other means known in the art.

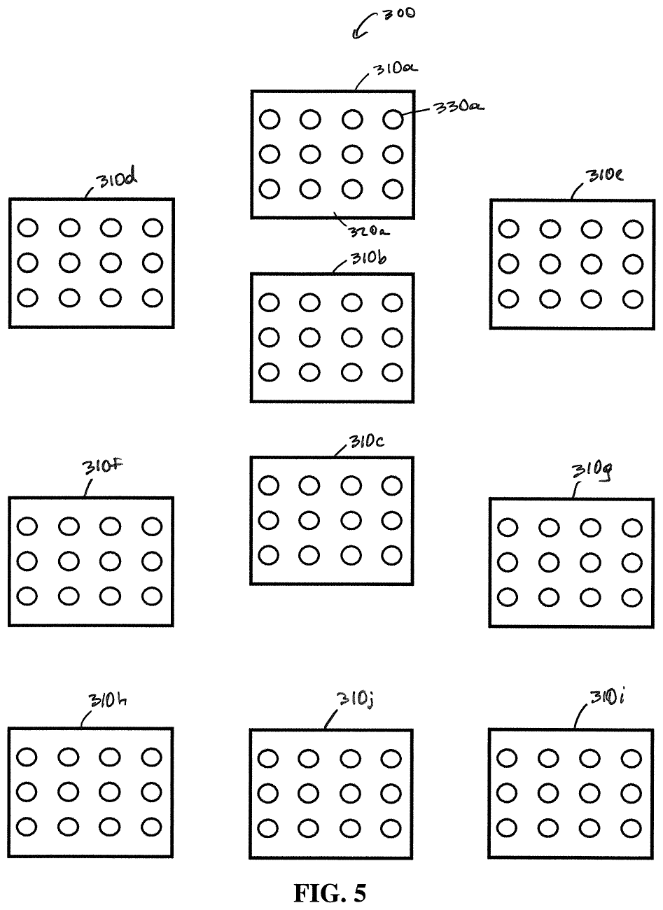

FIG. 5 shows a schematic illustration of another embodiment of a massage device of the present invention. In this embodiment, massage device 300 includes a wall-mountable support structure which may be one or more wall-mountable pegboard assemblies 310. In some embodiments, one or more massage elements may be attached to wall-mountable pegboard assemblies 310 (not shown in FIG. 5).

Massage device 300 includes a first pegboard assembly 310a, a second pegboard assembly 310b, a third pegboard assembly 310c, a fourth pegboard assembly 310d, a fifth pegboard assembly 310e, a sixth pegboard assembly 310f, a seventh pegboard assembly 310g, an eighth pegboard assembly 310h, a ninth pegboard assembly 310i, and a tenth pegboard assembly 310j. In alternate embodiments, massage device 300 may include a subset of pegboard assemblies 310a-310j, such as first pegboard assembly 310a, second pegboard assembly 310b, and third pegboard assembly 310c but excluding pegboard assemblies 310d-310j.

Pegboard assemblies 310 may be mounted to a wall or other solid support structure in the manner described herein for mounting upright assemblies 112 to a wall or other solid support structure or using any other means known in the art. Pegboard assemblies 310 may be mounted at varying heights, positions, and/or locations suitable for providing massage to users.

In some embodiments, pegboard assemblies 310 may be substantially identical to one another. In other embodiments, pegboard assemblies 310 may differ in shape or dimensions but otherwise be substantially identical to one another. The description below will refer to first pegboard assembly 310a but persons of ordinary skill in the art would appreciate that this description would apply equally to each of pegboard assemblies 310b-310j shown in FIG. 5.

First pegboard assembly 310a may include pegboard 320a. Pegboard 320a is generally planar and is typically constructed as a square or rectangular panel having flat mounting surfaces, although other shaped constructions with suitable mounting faces are also contemplated. Pegboard 320a may be a substantially solid body and may be formed of any rigid material such as metal alloys or wood. The dimensions of pegboard 320a may vary.

Pegboard 320a includes openings 330a, which extend through the front and back of the pegboard 320a. Openings 330a are distributed across the surface of pegboard 320a. In some embodiments, pegboard 320a includes one or more rows of openings distributed from the top to the bottom of pegboard 320a. The number, size, and shape of openings 330a, as well as the spacing between openings 330a, may vary. In some embodiments, openings 330a are circular. In other embodiments, openings 330a are defined as a first circle with an elongated circle extending downwardly. In some embodiments, openings 330a are used to mount one or more massage elements to first pegboard assembly 310a.

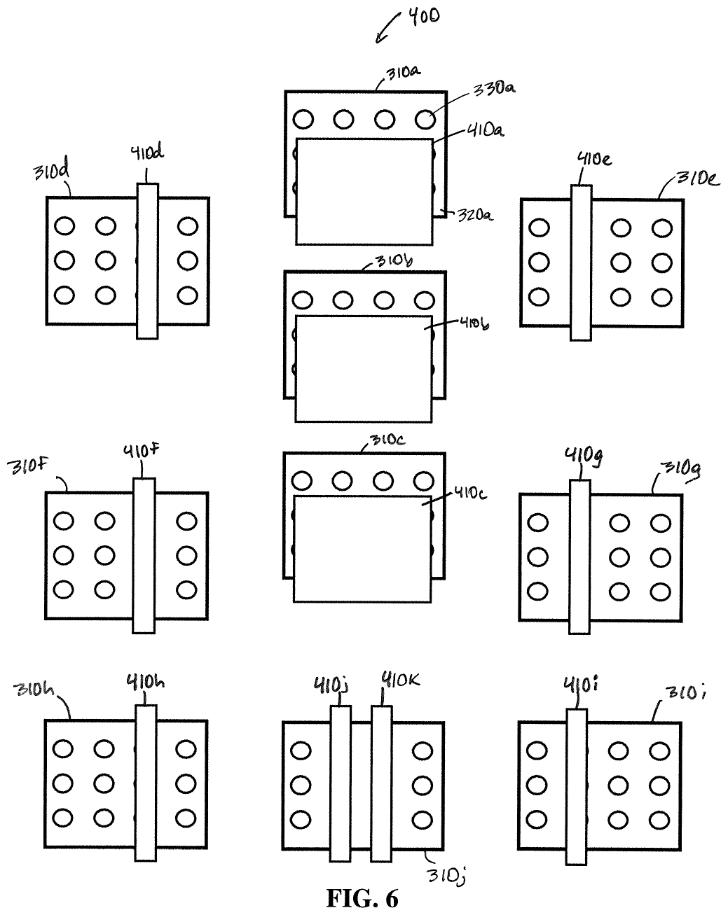

FIG. 6 shows a schematic illustration of another embodiment of a massage device of the present invention. Massage device 400 is similar to massage device 300 shown in FIG. 5 in all respects other than those specifically described herein. Like reference numerals in FIG. 6 refer to like features in FIG. 5.

As indicated above, massage devices of the present invention may optionally further include one or more massage elements. Massage elements of the present invention may take a variety of forms and any massage element can be used with the massage devices described herein. Various embodiments of massage elements that may be used with the massage devices of the present invention are described below.

Massage device 400 may include massage elements 410. More specifically, in this embodiment, massage device 400 includes massage elements 410a, 410b, 410c, 410d, 410e, 410f, 410g, 410h, 410i, 410j, and 410k. Persons of ordinary skill in the art would appreciate that massage device 400 may include all or a subset of massage elements 410 shown in FIG. 6. Further, it will be understood that massage elements 410 may be mounted at different locations on massage device 400 depending on the application.

In some embodiments, massage element 410a may be mounted to first pegboard assembly 310a of massage device 400. Preferably, massage element 410a provides massage to one or more of a user's cervical, deltoid, or thoracic regions and/or soft tissues generally located within one or more of these regions including but not limited to a user's cervical paraspinal muscles, trapezius muscles, deltoid muscles, or rhomboid muscles. Massage element 410a may take many forms, including but not limited to the exemplary embodiment shown in FIGS. 7A-7C and described below.

In some embodiments, massage element 410b may be mounted to second pegboard assembly 310b of massage device 400. Preferably, massage element 410b provides massage to a user's thoracic region and/or soft tissues generally located within this region including but not limited to a user's latissimus dorsi muscles or thoracic paraspinal muscles. Massage element 410b may take many forms, including but not limited to the exemplary embodiment shown in FIGS. 8A-8C and described below.

In some embodiments, massage element 410c may be mounted to third pegboard assembly 310c of massage device 400. Preferably, massage element 410c provides massage to one or more of a user's lumbar or gluteal regions and/or soft tissues generally located within one or more of these regions including but not limited to a user's thoracic paraspinal muscles, oblique muscles, or gluteus maximus muscles. Massage element 410c may take many forms, including but not limited to the exemplary embodiment shown in FIGS. 9A-9C and described below.

In some embodiments, massage elements 410d and 410e may be mounted to fourth pegboard assembly 310d and fifth pegboard assembly 310e, respectively, of massage device 400. Preferably, massage elements 410d and 410e provide massage to a user's deltoid regions and/or soft tissues generally located within these regions including but not limited to a user's deltoid muscles. Massage elements 410d and 410e may take many forms, including but not limited to the exemplary embodiment shown in FIGS. 10A-10C and described below.

In some embodiments, massage elements 410f and 410g may be mounted to sixth pegboard assembly 310f and seventh pegboard assembly 310g, respectively, of massage device 400. Preferably, massage elements 410f and 410g provide massage to a user's gluteal region and/or soft tissues generally located within this region including but not limited to a user's iliotibial bands. Massage elements 410f and 410g may take many forms, including but not limited to the exemplary embodiment shown in FIGS. 11A-11C and described below.

In some embodiments, massage elements 410h and 410i may be mounted to eighth pegboard assembly 310h and ninth pegboard assembly 310i, respectively, of massage device 400. Preferably, massage elements 410h and 410i provide massage to a user's lower limb regions and/or soft tissues generally located within these regions including but not limited to the lateral heads of a user's gastrocnemius muscles. Massage elements 410h an 410i may take many forms, including but not limited to the exemplary embodiment shown in FIGS. 12A-12C and described below.

In some embodiments, massage elements 410j and 410k may be mounted to tenth pegboard assembly 310j of massage device 400. Preferably, massage elements 410j and 410k provide massage to a user's lower limb regions and/or soft tissues generally located within these regions including but not limited to the medial heads of a user's gastrocnemius muscles. Massage element 410j and 410k may take many forms, including but not limited to the exemplary embodiment shown in FIGS. 12A-12C and described below.

Massage elements 410 may be mounted to massage device 400 in a variety of ways. In some embodiments, massage elements 410 may include a mounting mechanism (not shown in FIG. 6). For example, mounting mechanism may include one or more pins situated on massage elements 400 that may be inserted into one or more openings 330 in pegboards 320 of pegboard assemblies 310 to removably couple one or more massage elements 410 to massage device 400. In embodiments in which openings 330 are defined as a first circle with an elongated circle extending downwardly as described above, one or more pins of mounting mechanism of massage elements 410 may be defined as a first rod member terminating in a bulbous end, which may be inserted into one or more openings 330 before sliding down into a locked position such that the one or more massage elements 410 are securely and removably coupled to massage device 400. In other embodiments, alternate mounting mechanisms may be used to facilitate coupling massage elements 410 to massage device 400, including but not limited to screws, bolts, or any other suitable means to facilitate coupling. In other embodiments, massage elements 410 may be permanently attached to massage device 400. In some embodiments, massage elements 410 may be affixed at various locations across pegboard assemblies 310 to accommodate users of varying size or height.

Embodiments of the present invention also include massage elements that may be used together or separately from the massage devices described herein. Referring now to FIGS. 7-12, various embodiments of massage elements of the present invention are illustrated and described below.

FIGS. 7A-7C illustrate one embodiment of a massage element of the present invention. In this embodiment, massage element 500 includes a body 510, a first pair of arms 530, a second pair of arms 540, one or more prongs 550, and a pair of legs 560.

Body 510 of massage element 500 includes a pair of side members 512 and a connecting member 518 extending between side members 512. In some embodiments, side members 512 and connecting member 518 may be oriented to form a generally H-shaped body 510. In other embodiments, side members 512 and connecting member 518 may be oriented in other ways, such as to form a generally U-shaped body 510. Side members 512 include a first end 514 and a second end 516. The first end 514 and second end 516 are opposite one another with side member 512 extending between.

First pair of arms 530 extend vertically from first ends 514 of side members 512. One or more massage heads 532 may be spaced along the length of arms 530 and may be positioned to contact a user's cervical region and/or soft tissues in this region. Preferably, massage heads 532 contact the user at or near locations on the user's body generally corresponding to points 90a-c and 91a-c on human body 10 in FIG. 1.

Second pair of arms 540 may be generally perpendicular to side members 512 of body 510 and extend outwardly from second ends 516 of side members 512. Second pair of arms 540 each include a first end 542 and a second end 544. The first end 542 and second end 544 are opposite one another with the arm 540 extending between.

One or more prongs 550 may extend upwardly from each of arms 540 and terminate with massage heads 552. Prongs 550 may project forward to position massage heads 552 so that massage heads 552 contact a user's thoracic and/or deltoid regions and/or soft tissues in these regions. Preferably, massage heads 552 contact the user at or near locations on the user's body generally corresponding to points 90d-e and 91d-e on human body 10 in FIG. 1.

The pair of legs 560 extend downwardly from arms 540. One or more massage heads 562 may be spaced along the length of legs 560 and may be positioned to contact a user's thoracic region and/or soft tissues in this region. Preferably, massage heads 562 contact the user at or near locations on the user's body generally corresponding to points 90h-i and 91h-i on human body 10 in FIG. 1.

Optionally, massage element 500 may further include mounting mechanism 580 to facilitate coupling of massage element 500 to massage devices of the present invention. Mounting mechanism 580 may include any of the mounting mechanisms described above. For example, mounting mechanism 580 may include one or more pins (not shown) situated on body 510 of massage element 500. Massage element 500 may be mounted to any of the massage devices of the present invention described herein.

FIGS. 8A-8C illustrate another embodiment of a massage element of the present invention. In this embodiment, massage element 600 includes a body 610. Body 610 includes a pair of side members 612 and a connecting member 618 extending between side members 612. In some embodiments, side members 612 and connecting member 618 may be oriented to form a generally H-shaped body 610. In other embodiments, side members 612 and connecting member 618 may be oriented in other ways, such as to form a generally U-shaped body 610.

One or more massage heads 620 may be spaced along the length of side members 612 and maybe positioned to contact a user's thoracic region. Preferably, massage heads 620 contact the user at or near locations on the user's body generally corresponding to points 90j-1 and 91j-1 on human body 10 in FIG. 1.

Optionally, massage element 600 may further include mounting mechanism 680 to facilitate coupling of massage element 600 to massage devices of the present invention. Mounting mechanism 680 may include any of the mounting mechanisms described above. For example, mounting mechanism 680 may include one or more pins (not shown) situated on body 610 of massage element 600. Massage element 600 may be mounted to any of the massage devices of the present invention described herein.

FIGS. 9A-9C illustrate another embodiment of a massage element of the present invention. In this embodiment, massage element 700 includes a body 710, a pair of arms 730, and a pair of legs 740.

Body 710 of massage element 700 includes a pair of side members 712 and a connecting member 718 extending between side members 712. In some embodiments, side members 712 and connecting member 718 may be oriented to form a generally H-shaped body 710. In other embodiments, side members 712 and connecting member 718 may be oriented in other ways, such as to form a generally U-shaped body 710. Side members 712 include a first end 714 and a second end 716. The first end 714 and second end 716 are opposite one another with side member 712 extending between.

The pair of arms 730 extend vertically from first ends 714 of side members 712. One or more massage heads 732 may be spaced along the length of arms 730 and may be positioned to contact a user's lumbar region and/or soft tissues in this region. Preferably, massage heads 732 contact the user at or near locations on the user's body generally corresponding to points 90m-n and 91m-n on human body 10 in FIG. 1.

The pair of legs 740 extend downwardly and outwardly from the second ends 716 of side members 712. One or more massage heads 742 may be spaced along the length of legs 742 and may be positioned to contact a user's gluteal region. Preferably, massage heads 742 contact the user at or near locations on the user's body generally corresponding to points 90o-p and 910-p on human body 10 in FIG. 1.

Optionally, massage element 700 may further include mounting mechanism 780 to facilitate coupling of massage element 700 to the massage devices of the present invention. Mounting mechanism 780 may include any of the mounting mechanisms described above. For example, mounting mechanism 780 may include one or more pins (not shown) situated on body 710 of massage element 700. Massage element 700 may be mounted to any of the massage devices of the present invention described herein.

FIGS. 10A-10C illustrate another embodiment of a massage element of the present invention. In this embodiment, massage element 800 includes a body 810 and one or more prongs 830.

Body 810 of massage element 800 is generally planar and is typically constructed as a square or rectangular panel having flat mounting surfaces, although other shaped constructions with suitable mounting faces are also contemplated. Body 810 includes a first end 812 and a second end 814, which are opposite one another with body 810 extending between.

One or more prongs 830 may extend outwardly from body 810 and terminate with massage heads 832. Prongs 830 may position massage heads 832 so that massage heads 832 contact a user's deltoid region and/or soft tissues in this region. Preferably, massage heads 832 contact the user at or near locations on the user's body generally corresponding to points 90f-g and 91f-g on human body 10 in FIG. 1.

Optionally, massage element 800 may further include mounting mechanism 880 to facilitate coupling of massage element 800 to massage devices of the present invention. Mounting mechanism 880 may include any of the mounting mechanisms described above. For example, mounting mechanism 880 may include one or more pins (not shown) situated on body 810 of massage element 800. Massage element 800 may be mounted to any of the massage devices of the present invention described herein.

FIGS. 11A-11C illustrate another embodiment of a massage element of the present invention. In this embodiment, massage element 900 includes a body 910 and one or more prongs 930.

Body 910 of massage element 900 is generally planar and is typically constructed as a square or rectangular panel having flat mounting surfaces, although other shaped constructions with suitable mounting faces are also contemplated. Body 910 includes a first end 912 and a second end 914, which are opposite one another with body 910 extending between.

One or more prongs 930 may extend outwardly from body 910 and terminate with massage heads 932. Prongs 930 may position massage heads 932 so that massage heads 932 contact a user's gluteal region and/or soft tissues in this region. Preferably, massage heads 932 contact the user at or near locations on the user's body generally corresponding to points 90q-s and 91q-s on human body 10 in FIG. 1.

Optionally, massage element 900 may further include mounting mechanism 980 to facilitate coupling of massage element 900 to massage devices of the present invention. Mounting mechanism 980 may include any of the mounting mechanisms described above. For example, mounting mechanism 980 may include one or more pins (not shown) situated on body 910 of massage element 900. Massage element 900 may be mounted to any of the massage devices of the present invention described herein.

FIGS. 12A-12C illustrate another embodiment of a massage element of the present invention. In this embodiment, massage element 1000 includes a body 1010 and one or more prongs 1030.

Body 1010 of massage element 1000 is generally planar and is typically constructed as a square or rectangular panel having flat mounting surfaces, although other shaped constructions with suitable mounting faces are also contemplated. Body 1010 includes a first end 1012 and a second end 1014, which are opposite one another with body 1010 extending between.

One or more prongs 1030 may extend outwardly from body 1010 and terminate with massage heads 1032. Prongs 1030 may position massage heads 1032 so that massage heads 1032 contact a user's lower limb region and/or soft tissues in this region. Preferably, in some embodiments, massage heads 1032 contact the user at or near locations on the user's body generally corresponding to points 90t-u and 91t-u on human body 10 in FIG. 1. In other preferred embodiments, massage heads 1032 contact the user at or near locations on the user's body generally corresponding to points 90v-w and 91v-w on human body 10 in FIG. 1.

Optionally, massage element 1000 may further include mounting mechanism 1080 to facilitate coupling of massage element 1000 to massage devices of the present invention. Mounting mechanism 1080 may include any of the mounting mechanisms described above. For example, mounting mechanism 1080 may include one or more pins (not shown) situated on body 1010 of massage element 1000. Massage element 1000 may be mounted to any of the massage devices of the present invention described herein.

FIGS. 7-12 are intended to be exemplary and persons of ordinary skill in the art would understand that massage elements 500, 600, 700, 800, 900, and 1000 and/or individual components of massage elements 500, 600, 700, 800, 900, and 1000 may vary in size. It will be understood that, for example, massage elements 500, 600, 700, 800, 900, and 1000 may be larger or smaller to accommodate users having different body shapes or sizes. It will further be understood that components of massage elements 500, 600, 700, 800, 900, and 1000 including but not limited to bodies, side members, connecting members, arms, legs, and/or prongs of massage elements 500, 600, 700, 800, 900, and 1000 may be lengthened or shortened to accommodate users having different body shapes or sizes. For example, referring again to FIGS. 7A-7C, connecting member 518 of massage element 500 may be shortened or lengthened for different users to allow massage heads of massage element 500 to simultaneously contact a user in or at the regions, locations, and/or points referred to above.

Massage elements 500, 600, 700, 800, 900, and 1000 described above and illustrated in FIGS. 7-12 may be made of plastic by injection molding, gas assist injection molding or other appropriate material and/or fabrication method such as three-dimensional printing. The individual components of massage elements 500, 600, 700, 800, 900, and 1000 may be fabricated separately and connected together using known methods or may be fabricated as a single piece.

The various massage heads of massage elements 500, 600, 700, 800, 900, and 1000 described above may be made of any appropriate material such as a hard smooth plastic. Preferably, the material will be heat resistant, chemical resistant, and biologically inert. It may be advantageous to fabricate the massage heads from a hard smooth material to allow appropriate creams or gels, such as massage or pain creams, to be applied to the massage head prior to use. Additionally, use of a hard smooth material would further advantageously allow the massage heads to be safely cleaned with commercial cleaning products without damaging the massage heads.

In some embodiments, massage heads of the massage elements described above may provide vibration and/or heat to a user. The intensity of the vibration and/or heat of each individual massage element and/or massage head may be controlled by a user of the massage devices and/or massage elements described herein. Power may be supplied to the massage elements and/or massage heads via a battery. Alternately, massage devices and/or massage elements of the present invention may incorporate circuitry to transfer power from a standard wall outlet to each massage element and/or massage head.

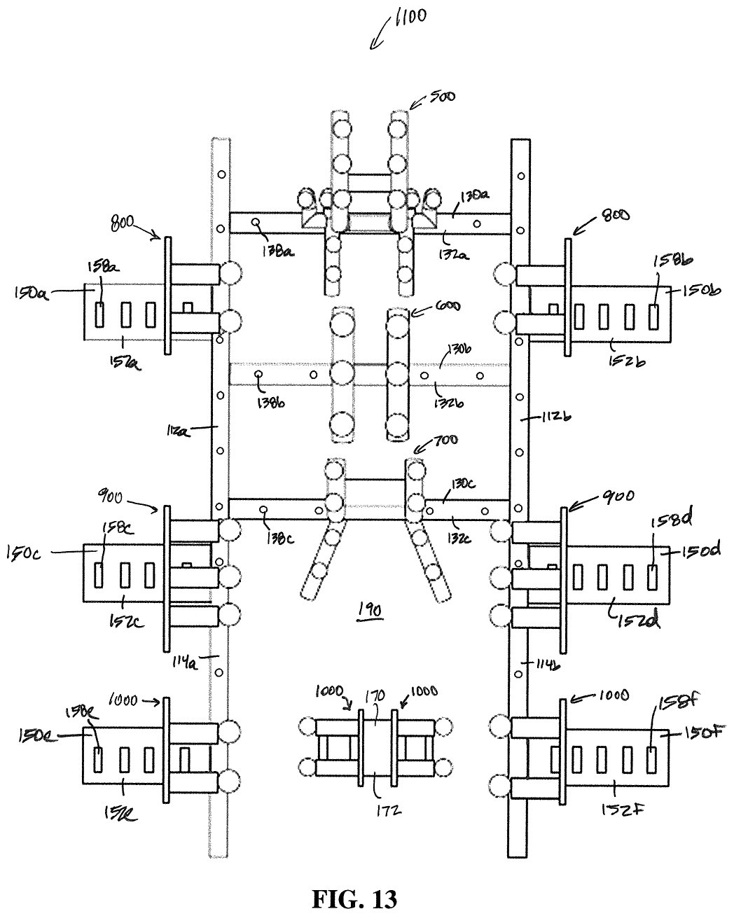

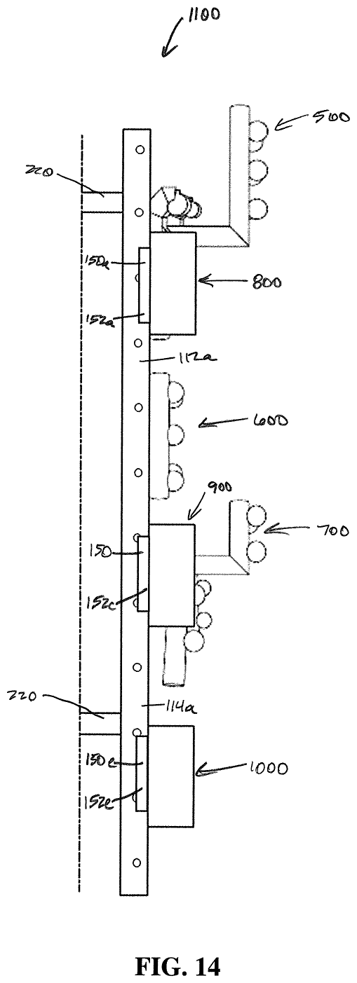

FIGS. 13 and 14 show schematic illustrations of another embodiment of a massage device of the present invention. Massage device 1100 is similar to massage device 200 shown in FIGS. 3 and 4 in all respects other than those specifically described herein. Like reference numerals in FIGS. 13 and 14 refer to like features in FIGS. 3 and 4.

In this embodiment, massage device 1100 includes massage elements 500, 600, 700, 800, 900, and 1000 shown in FIGS. 7-12 in place of massage elements 210a-210k in the embodiment shown in FIGS. 3 and 4. Persons of ordinary skill in the art would appreciate that massage device 1100 may include all or a subset of massage elements 500, 600, 700, 800, 900, and 1000 shown in FIGS. 13 and 14. Further, it will be understood that massage elements 500, 600, 700, 800, 900, and 1000 may be mounted at different locations on massage device 1100 depending on the application.

In some embodiments, massage element 500 may be mounted to first cross bar assembly 130a of massage device 1100. Preferably, massage element 500 provides massage to one or more of a user's cervical, deltoid, or thoracic regions and/or soft tissues generally located within one or more of these regions including but not limited to a user's cervical paraspinal muscles, trapezius muscles, deltoid muscles, or rhomboid muscles.

In some embodiments, massage element 600 may be mounted to second cross bar assembly 130b of massage device 1100. Preferably, massage element 600 provides massage to a user's thoracic region and/or soft tissues generally located within this region including but not limited to a user's latissimus dorsi muscles or thoracic paraspinal muscles.

In some embodiments, massage element 700 may be mounted to third cross bar assembly 130c of massage device 1100. Preferably, massage element 700 provides massage to one or more of a user's lumbar or gluteal regions and/or soft tissues generally located within one or more of these regions including but not limited to a user's thoracic paraspinal muscles, oblique muscles, or gluteus maximus muscles.

In some embodiments, massage elements 800 may be mounted to first lateral assembly 150a and second lateral assembly 150b of massage device 1100. Preferably, massage elements 800 provide massage to a user's deltoid regions and/or soft tissues generally located within these regions including but not limited to a user's deltoid muscles.

In some embodiments, massage elements 900 may be mounted to third lateral assembly 150c and fourth lateral assembly 150d of massage device 1100. Preferably, massage elements 900 provide massage to a user's gluteal region and/or soft tissues generally located within this region including but not limited to a user's iliotibial bands.

In some embodiments, massage elements 1000 may be mounted to fifth lateral assembly 150e and sixth lateral assembly 150f of massage device 1100. Preferably, massage elements 1000 provide massage to a user's lower limb regions and/or soft tissues generally located within these regions including but not limited to the lateral heads of a user's gastrocnemius muscles.

In some embodiments, massage elements 1000 may be mounted to medial assembly 170 of massage device 1100. Preferably, massage elements 1000 provide massage to a user's lower limb regions and/or soft tissues generally located within these regions including but not limited to the medial heads of a user's gastrocnemius muscles.

Massage elements 500, 600, 700, 800, 900, and 1000 may be mounted to massage devices of the present invention including massage device 1100 in a variety of ways. As described above, massage elements 500, 600, 700, 800, 900, and 1000 may include a mounting mechanism (not shown in FIGS. 13 and 14). For example, mounting mechanism may include one or more pins situated on massage elements 500, 600, 700, 800, 900, and 1000 that may be inserted into one or more openings 138 in main cross bars 132 of cross bar assemblies 130, one or more openings 158 in panel portion 152 of lateral assemblies 150, and/or one or more openings 178 in panel portion 172 of medial assembly 170 to removably couple one or more massage elements 500, 600, 700, 800, 900, and 1000 to massage device 1100. In embodiments in which openings 138, 158, and/or 178 are defined as a first circle with an elongated circle extending downwardly as described above, one or more pins of mounting mechanism of massage elements 500, 600, 700, 800, 900, and 1000 may be defined as a first rod member terminating in a bulbous end, which may be inserted into one or more openings 138, 158, and/or 178 before sliding down into a locked position such that the one or more massage elements 500, 600, 700, 800, 900, and 1000 are securely and removably coupled to massage device 1100. In other embodiments, alternate mounting mechanisms may be used to facilitate coupling massage elements 500, 600, 700, 800, 900, and 1000 to massage device 1100, including but not limited to screws, bolts, or any other suitable means to facilitate coupling. In other embodiments, massage elements 500, 600, 700, 800, 900, and 1000 may be permanently attached to massage device 1100. In some embodiments, massage elements 500, 600, 700, 800, 900, and 1000 may be affixed at various locations across main cross bars 132 of cross bar assemblies 130, panel portion 152 of lateral assemblies 150, and/or panel portion 172 of medial assembly 170 to accommodate users of varying size or height.

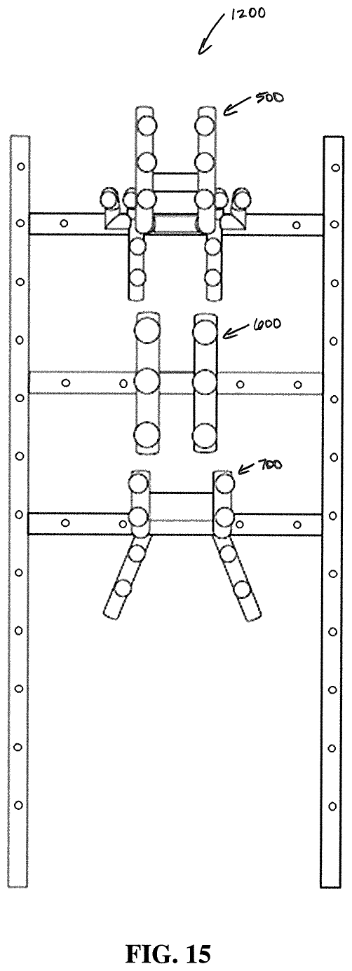

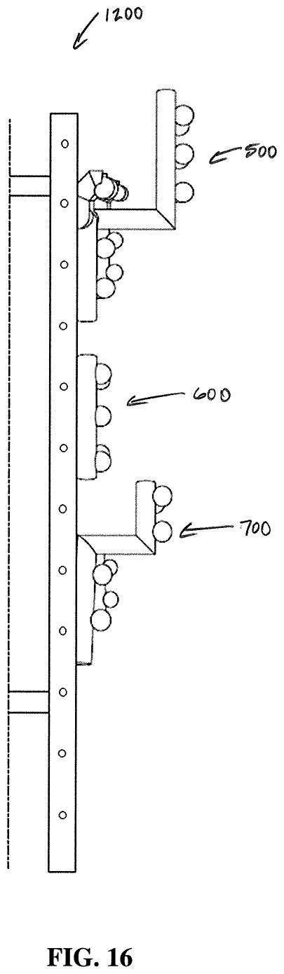

FIGS. 15 and 16 show schematic illustrations of another embodiment of a massage device of the present invention. Massage device 1200 is similar to massage device 1100 shown in FIGS. 13 and 14 in all respects other than those specifically described herein. Like reference numerals in FIGS. 15 and 16 refer to like features in FIGS. 13 and 14.

As described above, persons of ordinary skill in the art would appreciate that massage devices of the present invention may include all or a subset of the massage elements described and/or shown herein. For example, massage device 1200 shown in FIGS. 15 and 16 includes massage elements 500, 600, and 700 but does not include massage elements 800, 900, or 1000 as was shown in FIGS. 13 and 14. Massage device 1200 further does not include optional lateral assemblies 150 or optional medial assembly 170 as was shown in FIGS. 13 and 14.

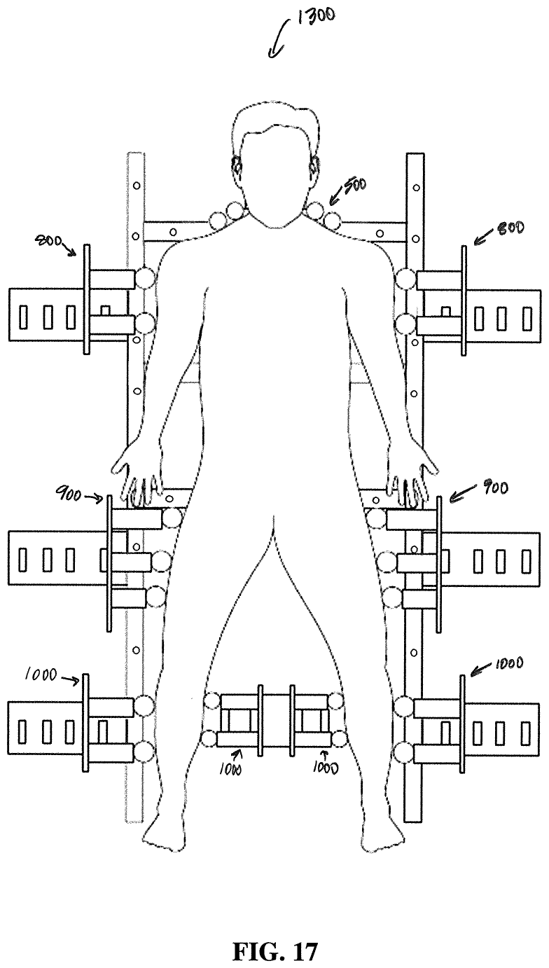

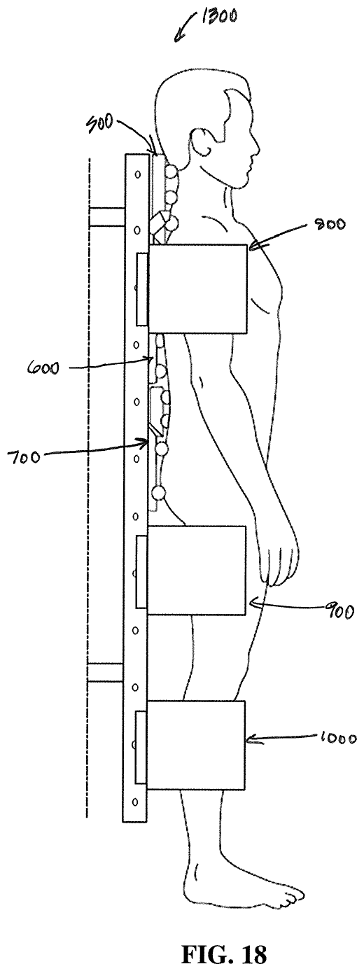

FIGS. 17 and 18 show schematic illustrations of another embodiment of a massage device of the present invention. In this embodiment, massage device 1300 is similar to massage device 1100 shown in FIGS. 13 and 14 in all respects other than those specifically described herein. Like reference numerals in FIGS. 17 and 18 refer to like features in FIGS. 13 and 14.

In this embodiment, massage device 1300 is depicted in use by a user for self-administering massage. Facing away from massage device 1300, a user stands adjacent to and generally in the center of massage device 1300. The user then causes one or more of the massage heads on massage elements 500, 600, 700, 800, 900, and/or 1000 to contact his or her body by, for example, stepping or leaning backwards in the direction of massage device 1300. Massage heads located on massage elements 500, 600, 700, 800, 900, and/or 1000 will naturally contact the user's body within certain regions and/or at or near specific locations and/or points on the user's body, as described herein. The user may also adjust the position of components of massage device 1300 and/or massage elements 500, 600, 700, 800, 900, and/or 1000 in the manner described herein to allow massage heads on massage elements 500, 600, 700, 800, 900, and/or 1000 to contact the user's body in or at the regions, locations, and/or points on the user's body described above.

The user may lean his or her body into massage heads on massage elements 500, 600, 700, 800, 900, and/or 1000 to apply pressure from the massage heads to various areas of the user's body in contact with the massage heads. The user may control the amount of pressure applied by the massage heads to the user's body by pushing or pressing his or her body more or less firmly against one or more of the massage heads. The user may also control the precise location at which the massage heads contact the user's body by shifting his or her body relative to the massage heads. Constant pressure may be applied for a set period of time or until the user experiences a therapeutic benefit such as relief of pain or muscle tension. Instead of constant pressure, a user may also vary the amount of pressure applied and/or shift his or her body position to cause the massage heads to knead or otherwise manipulate areas of the user's body in contact with the massage heads.

As will be apparent to persons of ordinary skill in the art based on the above description, the massage devices and massage elements of the present invention offer many benefits. For example, in some embodiments the massage devices of the present invention are mounted on a wall or other support structure, allowing users to self-administer massage. The wall-mounted massage devices of the present invention also allow users to massage areas of the body that are otherwise difficult to reach and to control the amount of pressure applied by the device to the user's body. Further, the massage devices of the present invention preferably include a plurality of massage elements for providing massage simultaneously to different areas of a user's body. This allows users to massage many different areas of the user's body at once for improved efficacy and convenience. Moreover, the unique design of the massage elements of the present invention, including but not limited to the design and orientation of the massage heads, result in superior efficacy.

Massage devices and massage elements of the present invention may beneficially be used in a variety of different locations, including clinics, hospitals, physical therapy centers, gyms, spas, or any other location individuals may wish to receive massage therapy. Advantageously, because a user has the ability to self-administer massage using the massage devices of the present invention, massage devices disclosed herein may also be used in a user's own home.

With respect to the above description, it is to be realized that the optimum dimensional relationship for the various components of the inventions described above include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It should be understood that the various materials, shapes, and configurations of all the massage devices, massage elements, massage heads, or components thereof described herein may be interchangeable. For example, a description of a connection as being provided by bolts or screws may be applied to other massage devices, massage elements, massage heads, or components thereof than the one for which it is described. Likewise, unless mutually exclusive, particular aspects of the massage devices described herein, including but not limited to couplings, coupling mechanisms, mounts, and mounting mechanisms, may be utilized in different locations in the massage devices of the present invention. Similarly, unless mutually exclusive, particular aspects of the massage elements described herein may be utilized in different locations in the same or different massage elements of the present invention. For example, massage heads described with reference to one massage element may be utilized for each of the massage elements of the present invention.

Unless otherwise defined, all technical and scientific terms used herein have the same meaning as commonly understood by one of ordinary skill in the art encompassing the general inventive concepts. The terminology set forth in this detailed description is for describing particular embodiments only and is not intended to be limiting of the general inventive concepts. As used in this detailed description and the appended claims, the singular forms “a,” “an,” and “the” are intended to include the plural forms as well, unless the context clearly indicates otherwise. As used herein the terms comprise(s), include(s), having, has, with, contain(s) and variants thereof are intended to be open ended transitional phrases, terms, or words that do not preclude the possibility of additional steps or structure.

Unless otherwise indicated, all numbers, such as for example, numbers expressing percentages, and other numerical values used in the specification and claims, are to be understood as being modified in all instances by the term “about.” Accordingly, unless otherwise indicated, the numerical properties set forth in the specification and claims are approximations that may vary depending upon the suitable properties sought to be obtained in the embodiments of the invention. Notwithstanding that the numerical ranges and parameters setting forth the broad scope of the general inventive concepts are approximations, the numerical values set forth in the specific examples are reported as precisely as possible. Any numerical values, however, inherently contain certain errors necessarily resulting from error found in their respective measurements.

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1-39. (canceled)

40. A massage device for providing massage to a user's body, comprising:
a wall-mountable support structure; and
one or more massage elements attached to the wall-mountable support structure.

41. The massage device of claim 40, wherein the wall-mountable support structure comprises a wall-mountable frame.

42. The massage device of claim 41, wherein the wall-mountable frame includes:
one or more upright assemblies;
one or more cross bar assemblies;
one or more lateral assemblies; and
one or more medial assemblies.

43. The massage device of claim 40, wherein the wall-mountable support structure comprises one or more wall-mountable pegboard assemblies.

44. The massage device of claim 43, wherein each of the one or more wall-mountable pegboard assemblies include a pegboard with a plurality of openings.

45. The massage device of claim 40, wherein the one or more massage elements include a massage element for providing massage to a user's cervical paraspinal muscles, trapezius muscles, deltoid muscles, and rhomboid muscles comprising:
a body with a pair of side members and a connecting member extending between the side members;
a first pair of arms that extend vertically from the side members of the body;
a second pair of arms that extend outwardly from the side members of the body;
one or more prongs that extend upwardly from the second pair of arms; and
a pair of legs that extend downwardly from the second pair of arms;
wherein the first pair of arms include one or more massage heads positioned to contact the user's cervical paraspinal muscles;
wherein the one or more prongs include one or more massage heads positioned to contact the user's trapezius and deltoid muscles; and
wherein the pair of legs include one or more massage heads positioned to contact the user's rhomboid muscles.

46. The massage device of claim 40, wherein the one or more massage elements include a massage element for providing massage to a user's latissimus dorsi muscles and thoracic paraspinal muscles, the massage element comprising:
a body with a pair of side members and a connecting member extending between the side members;
wherein the side members include one or more massage heads positioned to contact the user's latissimus dorsi muscles and thoracic paraspinal muscles.

47. The massage device of claim 40, wherein the one or more massage elements include a massage element for providing massage to a user's thoracic paraspinal muscles, oblique muscles, and gluteus maximus muscles, the massage element comprising:
a body with a pair of side members and a connected member extending between the side members;
a pair of arms that extend vertically from the side members of the body; and
a pair of legs that extend downwardly and outwardly from the side members of the body;
wherein the first pair of arms include one or more massage heads positioned to contact the user's thoracic paraspinal muscles and oblique muscles; and
wherein the first pair of legs include one or more massage heads positioned to contact the user's gluteus maximus muscles.

48. The massage device of claim 40, wherein the one or more massage elements include a massage element for providing massage to a user's deltoid muscles, the massage element comprising:
a planar body; and
one or more prongs that extend outwardly from the planar body;
wherein the one or more prongs include one or more massage heads positioned to contact the user's deltoid muscles.

49. The massage device of claim 40, wherein the one or more massage elements include a massage element for providing massage to a user's iliotibial bands, the massage element comprising:
a planar body; and
one or more prongs that extend outwardly from the planar body;
wherein the one or more prongs include one or more massage heads positioned to contact the user's iliotibial bands.

50. The massage device of claim 40, wherein the one or more massage elements include a massage element for providing massage to a lateral head of a user's gastrocnemius muscles, the massage element comprising:
a planar body; and
one or more prongs that extend outwardly from the planar body;
wherein the one or more prongs include one or more massage heads positioned to contact the lateral head of the user's gastrocnemius muscles.

51. The massage device of claim 40, wherein the one or more massage elements include a massage element for providing massage to a medial head of a user's gastrocnemius muscles, the massage element comprising:
a planar body; and
one or more prongs that extend outwardly from the planar body;
wherein the one or more prongs include one or more massage heads positioned to contact the medial head of the user's gastrocnemius muscles.

52. A massage device for providing massage to a user's body, comprising:
a wall-mountable support structure; and
one or more massage elements;
wherein the one or more massage elements include:
a first massage element with massage heads positioned to provide massage to the user's cervical paraspinal muscles, trapezius muscles, deltoid muscles, and rhomboid muscles;
a second massage element with massage heads positioned to provide massage to the user's latissimus dorsi muscles and thoracic paraspinal muscles; and
a third massage element with massage heads positioned to provide massage to the user's thoracic paraspinal muscles, oblique muscles, and gluteus maximus muscles.

53. The massage device of claim 52, wherein the one or more massage elements further include:
fourth and fifth massage elements each with massage heads positioned to provide massage to the user's deltoid muscles;
sixth and seventh massage elements each with massage heads positioned to provide massage to the user's iliotibial bands;
eighth and ninth massage elements each with massage heads positioned to provide massage to a lateral head of the user's gastrocnemius muscles; and
a tenth massage element with massage heads positioned to provide massage to a medial head of the user's gastrocnemius muscles.

54. The massage device of claim 52, wherein the wall-mountable support structure comprises a wall-mountable frame.

55. The massage device of claim 54, wherein the wall-mountable frame includes:
one or more upright assemblies;
one or more cross bar assemblies;
one or more lateral assemblies; and
one or more medial assemblies.

56. The massage device of claim 52, wherein the wall-mountable support structure comprises one or more wall-mountable pegboard assemblies.

57. The massage device of claim 56, wherein each of the one or more wall-mountable pegboard assemblies include a pegboard with a plurality of openings.

58. A massage device for providing massage to a user's body, comprising:
a wall-mountable support structure; and
one or more massage elements;
wherein the one or more massage elements include:
a first massage element for providing massage to a user's cervical paraspinal muscles, trapezius muscles, deltoid muscles, and rhomboid muscles, the first massage element comprising:
a body with a pair of side members and a connecting member extending between the side members;
a first pair of arms that extend vertically from the side members of the body;
a second pair of arms that extend outwardly from the side members of the body;
one or more prongs that extend upwardly from the second pair of arms; and
a pair of legs that extend downwardly from the second pair of arms;
wherein the first pair of arms include one or more massage heads positioned to contact the user's cervical paraspinal muscles;
wherein the one or more prongs include one or more massage heads positioned to contact the user's trapezius and deltoid muscles; and
wherein the pair of legs include one or more massage heads positioned to contact the user's rhomboid muscles;
a second massage element for providing massage to a user's latissimus dorsi muscles and thoracic paraspinal muscles, the second massage element comprising:
a body with a pair of side members and a connecting member extending between the side members;
wherein the side members include one or more massage heads positioned to contact the user's latissimus dorsi muscles and thoracic paraspinal muscles; and
a third massage element for providing massage to a user's thoracic paraspinal muscles, oblique muscles, and gluteus maximus muscles, the third massage element comprising:
a body with a pair of side members and a connected member extending between the side members;
a pair of arms that extend vertically from the side members of the body; and
a pair of legs that extend downwardly and outwardly from the side members of the body;
wherein the pair of arms include one or more massage heads positioned to contact the user's thoracic paraspinal muscles and oblique muscles; and
wherein the pair of legs include one or more massage heads positioned to contact the user's gluteus maximus muscles.

59. The massage device of claim 58, wherein the one or more massage elements further include:
fourth and fifth massage elements for providing massage to a user's deltoid muscles, the fourth and fifth massage elements comprising:
a planar body; and
one or more prongs that extend outwardly from the planar body;
wherein the one or more prongs include one or more massage heads positioned to contact the user's deltoid muscles;
sixth and seventh massage elements for providing massage to a user's iliotibial bands, the sixth and seventh massage elements comprising:
a planar body; and
one or more prongs that extend outwardly from the planar body;
wherein the one or more prongs include one or more massage heads positioned to contact the user's iliotibial bands;
eighth and ninth massage elements for providing massage to a lateral head of a user's gastrocnemius muscles, the eighth and ninth massage elements comprising:
a planar body; and
one or more prongs that extend outwardly from the planar body;
wherein the one or more prongs include one or more massage heads positioned to contact the lateral head of the user's gastrocnemius muscles;
a tenth massage element for providing massage to a medial head of a user's gastrocnemius muscles, the tenth massage element comprising:
a planar body; and
one or more prongs that extend outwardly from the planar body;
wherein the one or more prongs include one or more massage heads positioned to contact the medial head of the user's gastrocnemius muscles.
